(19) United States
(12) Patent Application Publication
(10) Pub. No.: US 2010/0060001 A1
(43) Pub. Date: Mar. 11, 2010

(54) WIND TURBINE SAFETY SYSTEM AND METHODS

(75) Inventor: Christopher W. Gabrys, Reno, NV (US)

Correspondence Address: HOLLAND & HART, LLP, P.O BOX 8749, DENVER, CO, 80201, US

(73) Assignee: MARIAH POWER, INC., Reno, NV (US)

(21) Appl. No.: 12/533,917

(22) Filed: Jul. 31, 2009

Related U.S. Application Data
(60) Provisional application No. 61/137,527, filed on Jul. 31, 2008.

(51) Int. Cl. F03D 7/00; F03D 9/00

(52) U.S. Cl. 290/44

(57) ABSTRACT

A wind turbine for extracting energy from the wind and providing electrical energy to a load. The wind turbine may include a rotor arranged to drive a generator, and an electronic controller for connecting the generator to an electrical load. The electronic controller operates to reduce the tip speed ratio of the turbine rotor as wind speed increases. The rotor is designed have a power coefficient at low values of tip speed ratios that becomes negative for wind speeds exceeding a predetermined wind speed value. The electronic controller cooperates with the turbine rotor such that the turbine rotor looses a positive power coefficient and the wind turbine slows when wind speeds exceed the predetermined wind speed value.

### CROSS REFERENCE TO RELATED APPLICATION

The present application claims the benefit of the filing date of U.S. Provisional Application No. 61/137,527, filed Jul. 31, 2008, the disclosure of which is incorporated, in its entirety, by reference.

### TECHNICAL FIELD

The present disclosure relates to wind turbines, and more particularly relates to systems and methods for controlling rotation speed of wind turbines.

### BACKGROUND

Wind turbines are used for electrical energy generation because of their economical power production and potential environmental benefits. Large wind turbines located in off shore or remote wind farms are increasingly being installed worldwide. Wind turbines can produce megawatts of electric power, consume little non-renewable energy resources, and have low pollution ramifications.

Another application for wind turbines is in small wind turbines, typically of 10 kilowatts peak power or less. Such small wind turbines have been deployed on farms for use in, for example, pumping water for irrigation and stock watering, and providing some electricity production. Use of small wind turbines has generally been limited. An additional emerging market opportunity for small wind turbines is in urban and suburban installations. In these installations, customers use small wind turbines to produce some of their own electric power and offset their utility bills through net metering. Urban and suburban wind turbines are typically located where people live, with installations on rooftops, in yards and along roadsides. Small wind turbines can reduce electricity transmission losses and the need for increased transmission lines.

One type of wind turbine, which can be constructed either as large or small sizes, is vertical axis wind turbines. Vertical axis turbines or cross-wind turbines have rotors that rotate about a vertical axis. One advantage of vertical axis wind turbines is that they readily capture and convert wind energy from changing direction and turbulent wind. Darrieus type turbines (also know as egg beater turbines) are the most common vertical axis turbines. Darrieus type turbines are typically more efficient than other types of vertical axis turbines because they utilize lift of the rotor blades to extract energy from the wind.

The life of wind turbines is a function of the stress on the mechanical components and the fatigue life of the respective materials. Wind loads and stress increase exponentially with wind speeds. Although a wind turbine may have a long life at the majority of typical wind speeds, a rare wind storm potentially can quickly cause a turbine failure. Mechanical failures can be prevented by oversizing the turbine components to handle the operating stresses of extreme wind events. However, such oversizing undesirably increases turbine costs and weight.

### SUMMARY

One aspect of the present disclosure relates to vertical axis wind turbines and related methods of operating such wind turbines. An example vertical axis wind turbine includes a rotor, a generator, and a controller. The controller is operable to control and electrical output of the generator. The controller may control the generator to modify a rotation speed of the rotor to control the electrical output of the generator. In one example, the controller activates circuitry to create a short in the generator that produces a reduction in the rotation speed of the rotor. The generator may include a set of windings and at least one permanent magnet. The short may occur in the winding to create a back electromotive force that opposes a magnetic force generated by rotation of the permanent magnet.

The rotation speed of the rotor may correlate to a wind speed that is driving the rotor. The controller may be operable based on a threshold wind speed to reduce the rotation speed of the rotor via control of the generator. The controller may also permit increased rotation speed of the rotor upon a reduction in the wind speed below the threshold wind speed.

The rotor may be a Darrieus type turbine rotor. The generator may be a synchronous generator having a plurality of permanent magnets. The threshold wind speed may be in the range of about 15 m/s to about 20 m/s.

Another aspect of the present disclosure relates to a wind turbine that includes a rotor, a generator, and a controller. The rotor is configured to rotate about a vertical axis. The generator is driven by rotation of the rotor. The controller is operatively coupled to the rotor and generator. The controller is operable to monitor a rotation speed of the rotor and control the generator to reduce the rotation speed of the rotor when the rotation speed exceeds a predetermined level.

A further aspect of the present disclosure relates to a method of controlling rotation speed of a wind turbine. The method includes providing a wind turbine having a rotor, a generator, and a controller, rotating the rotor with wind energy, rotating at least a portion of the generator with the rotor to create an electrical current, and controlling the generator with the controller to modify a rotation speed of the rotor when the rotation speed exceeds a predetermined level.

Further aspects of the method may relate to the generator including at least one fixed magnet and a set of windings, and controlling the generator includes creating an electrical short in the windings that creates a back electromotive force, the back electromotive force acting upon the fixed magnet to oppose rotation of the rotor. The step of controlling the generator may include providing a force within the generator that opposes rotation of the rotor. The method may further include controlling the generator to maintain a constant rotation speed of the rotor. Modifying the rotation speed may include reducing the rotation speed to create a reduced tip speed ratio of the rotor. The method may further include controlling the generator to maintain the rotation speed of the rotor at a maximum rotation speed for a given wind speed that is below the predetermined level. The method may further comprise electrically coupling the electrical current to a utility power grid. The predetermined level may correlate with wind speeds within the range of about 15 m/s to about 30 m/s. The predetermined level may correlate with a threshold wind speed, and the controller may permit an increase in rotation speed of the rotor when the wind speed decreases from the threshold wind speed.

Additional advantages and novel features will be set forth in the description which follows or can be learned by those skilled in the art through reading these materials or practicing the examples disclosed herein.

### BRIEF DESCRIPTION OF THE DRAWINGS

The accompanying drawings illustrate various embodiments and are a part of the specification. The illustrated embodiments are merely examples and do not limit the scope of the present disclosure.

FIG. 1 is a schematic elevation of a vertical axis wind turbine in accordance with the present disclosure.

FIG. 2 is a schematic partial cross-sectional view of a generator for use in a vertical axis wind turbine as shown in FIG. 1.

FIG. 2A is a schematic circuit diagram of a portion of an example wind turbine electronic circuitry in accordance with the present disclosure for use with the wind turbine of FIG. 1.

FIG. 2B is a schematic circuit diagram of a portion of another example wind turbine electronic circuitry in accordance with the present disclosure for use with the wind turbine of FIG. 1.

FIG. 3 is a schematic drawing of an example control system for a vertical axis wind turbine such as that shown in FIGS. 1 and 2 in accordance with the present disclosure.

FIG. 4 is a plot of a power coefficient versus tip speed ratio curve of a vertical axis wind turbine in accordance with the present disclosure.

FIG. 5 is an alternate plot of a power coefficient versus tip speed ratio curve of an example vertical axis wind turbine in accordance with the present disclosure.

FIG. 6 is a plot of a power versus tip speed ratio curve of an example vertical axis wind turbine in accordance with the present disclosure.

FIG. 7 is an alternate plot of a power versus tip speed ratio curve of an example vertical axis wind turbine in accordance with the present disclosure.

FIG. 8 is a second alternate plot of a power versus tip speed ratio curve of an example vertical axis wind turbine in accordance with the present disclosure.

FIG. 9 is a fatigue curve for steel for components of an example vertical axis wind turbine in accordance with the present disclosure.

FIG. 10 is a stress versus cycle life table of steel for an example vertical axis wind turbine in accordance with the present disclosure.

FIG. 11 is a wind speed versus top shaft stress table for an example vertical axis wind turbine in accordance with the present disclosure.

FIG. 12 is a stress calculation of fatigue life for the top shaft of an example vertical axis wind 20 turbine in accordance with the present disclosure.

FIG. 13 is a schematic drawing of an electronic controller for use in an example vertical axis wind turbine in accordance with the present disclosure.

FIG. 14 is a plot of the power versus RPM control for an example vertical axis wind turbine in accordance with the present disclosure.

FIG. 15 is a plot of power versus wind speed for an example vertical axis wind turbine in accordance with the present disclosure.

Throughout the drawings, identical reference numbers designate similar, but not necessarily identical, elements.

### DETAILED DESCRIPTION

The present disclosure relates to a wind turbine for extracting wind energy and providing electrical energy to a load. The wind turbine may include a Darrieus type turbine rotor, a synchronous generator, and an electronic controller. Output from the generator may be electrically coupled to an electrical load. The turbine rotor extracts energy from wind and drives the synchronous generator to produce electrical power. The electronic controller controls the electrical power from the synchronous generator and provides the power to the electrical load. The electronic controller operates to reduce the tip speed ratio of the turbine rotor as wind speed increases. A power coefficient of the turbine rotor may becomes negative at the operating tip speed ratio of the turbine rotor when the wind speed (and/or a correlating rotation speed of the turbine rotor) exceeds a predetermined value. The rotor may passively slows until the wind speed slows below the predetermined wind speed value.

Passively slowing of the rotor may include slowing without the use of a mechanical braking device. In at least one example, the rotor rotation speed is slowed using a back electromotive force (“back EMF”) that opposes rotation of the rotor. In some examples, the generator is used to apply an opposing rotational force to the rotor to reduce the rotation speed of the rotor. Typically, a short is created in the windings of the generator that creates a back EMF that opposes a magnetic force generated by rotation of at least one permanent magnet in the generator.

Wind turbines can be subjected to extreme loading conditions. Wind turbines can operate efficiently to extract as much energy as possible from wind in normal conditions including when only light wind is present. However, a wind turbine is preferably designed to be designed to also operate without failure when the wind speed is higher than typical, including less common wind storms and other high wind events. The force of wind or the wind load exerted onto a wind turbine generally increases with the square of the wind speed. This makes the design of a wind turbine a factor to achieve efficiently capture wind energy in low wind but still withstand the dramatically increased forces from wind during storms. Furthermore, a wind turbine is usually expected to operate for extended periods of time (e.g., 20 years or more) without sustaining structural failures or fatigue issues.

It is possible to stop turbines during high wind events in an attempt to prevent damage to the wind turbine. However, even a stopped wind turbine is still exposed to some of the same stresses from high wind since the wind is still impacting the structure. The only way to avoid high wind load stresses is to lower the wind turbine prior to a storm. Unfortunately, this solution is not a practical possibility in many cases because, for example, the required equipment is unavailable, the turbine is in a remote location, or available labor is not readily on call.

Despite being unable to preclude vertical axis turbines from exposure to high wind load stresses, the fatigue life of vertical axis wind turbines can in fact be substantially extended by stopping or substantially slowing rotation of the wind turbine when a certain level of wind speed exists. One particularly critical component of vertical axis wind turbines is the rotor shaft. Fatigue life for a given turbine component is a function of the stress, number of cycles and also the stress ratio, or low value stress divided by the high value of stress per cycle. The maximum stress remains essentially unchanged whether operating or stopped. However, both the number of cycles and the stress ratio are favorably affected by slowing rotation speed in extreme wind events. The number of cycles on the shaft of a vertical axis wind turbine is equal to the number of rotations when exposed to the high wind load stress. For a turbine rotating at 450 rpm, more than one million fatigue cycles can be accumulated in less than 2 days operation of high wind. For a slow rotation turbine, the fatigue cycles are just the equivalent of the number of high wind gusts encountered, or many thousands of times lower.

With turbine operation in extreme high winds, the stress ratio of the fatigue is equivalent to R=−1, or a cycle between full equal tension and full compression. This condition arises because the rotating turbine shaft will be deflected from the wind load. As the shaft rotates, each side of the shaft cycles between equivalent tension and compression from that deflection. In contrast, for a stopped or slowed turbine in the same extreme high winds, the stress ratio of the fatigue is more closely equivalent to R=0, or a cycle between full tension and zero tension, or even higher. This condition arises because a cycle is equivalent to a wind gust and the worst case would be for the wind to be gusting between zero wind and full wind speed.

It would be a conventional solution to stop a wind turbine operation in high wind periods by utilizing a separate wind speed sensor and control system to shut off turbine operation. However, such a sensor system would disadvantageously add significant costs and complexity. Further, a mechanical braking system capable of stopping a turbine rotor when providing full power in high winds would need to be extremely substantial. Likewise in a wind storm, the potential for numerous stopping events due to wind speed gusting would add additional modes of high stress cycles to the wind turbine system. It could be possible to reduce the number of braking stress cycles by shutting off for an extended period of time, once high wind is detected. Unfortunately, this approach would likely result in the wind turbine missing substantial energy production whenever periods of maximum production winds were present. It would be much more desirable to have an automatic system that would function reliably and passively in part by other methods such as, for example, at least one of electronic and aerodynamic methods.

At least some of the example wind turbines disclosed throughout are configured to extend the operating life of the wind turbine and reduce fatigue by significantly slowing rotation speed of the wind turbine as wind speed increases beyond a threshold level. The rotation speed of the rotor may be controlled by the electrical load that the controller applies to the generator. The electronic controller may control the amount of power flow from the generator and turbine rotor to the electrical load. The controller may regulate the voltage that is applied to the electrical load. During turbine operation in increasing wind speeds, the controller may reduce the operating tip speed ratio of the turbine rotor. The wind turbine continues to provide electrical power to the load even with reduced operating tip speed ratio. With further increases in wind speed beyond a predetermined or threshold level, the power coefficient of the turbine rotor eventually switches from a positive value to a negative value for the low operating tip speed ratio of the rotor.

The combined speed control from the electronic controller with a loss of positive torque in the rotor as wind speed increases may cooperate to passively stop the turbine rotor (i.e., stop without the use of a mechanical brake). The turbine rotor simply and automatically slows down as the wind speed becomes higher than the desired allowable operating range. In at least this embodiment, no mechanical braking or high braking stresses are required. Once the wind speeds have exceeded the desired maximum operating wind speed and the rotor has slowed, the turbine rotor will remain in the slowed state. The turbine rotor will only restart operation when the wind speeds below the threshold high wind speed level. The controller may permit the turbine rotor to self start as the rotor exhibits a positive power coefficient again. The functioning of the examples disclosed throughout may be dependent on both the electronic control to drive the operating tip speed ratio lower in increasing wind speeds and also an aerodynamic loss of rotor torque at low tip speed ratios as the wind speeds reach a certain level. Although a negative rotor power coefficient can be used to slow the rotor at high wind speeds, it is only negative for low values of rotor tip speed ratio. The power coefficient of the turbine rotor may continue to be positive in extreme high winds at higher tip speed ratios. Therefore, the combined functioning of both the electronic controller and the rotor aerodynamic performance may be particularly effective to achieve the benefits of the desired automatic wind turbine slowing in high wind conditions.

The wind turbine controller can reduce the operating tip speed ratio of the rotor to accomplish several different effects in the normal operating wind speed range. In one embodiment, the electronic controller stalls the turbine rotor and limits rotational speed to the maximum design rotational speed in increasing wind speeds such that the turbine rotor rotates near the maximum rotational speed prior to wind speeds sufficient to stop the turbine rotor. In this configuration, the wind turbine controls the rotor to track the peak power coefficient up until the rotor reaches its maximum structurally allowable rotational speed. As the wind speeds increase, the electronic controller increases the stall torque and maintains the turbine rotor approximately at it maximum allowable speed. This control can be accomplished by a look up table in the controller software that sets the power transfer from the generator to the electrical load at values that are based upon the instantaneous rotational speed. The electronic controller can measure the rotational speed by monitoring the frequency of the generator power. Upon reaching the rated rotational speed, the controller can much more steeply ramp the power transfer per rotational speed increase. The electronic controller thereby stalls the turbine rotor and limits the rotational speed to approximately the maximum value. Wind gusts can briefly result in spikes in the rotational speed and power to the load, but the steady state speed is limited and power is limited. At the upper limit of the allowable operating wind speed range, the rotor is typically rotating at its maximum rotational speed. Further increases in wind speed will thereby result in a reduced operating tip speed ratio for the rotor and the power coefficient of the rotor aerodynamically becomes negative for those wind speeds and tip speed ratios. As a result, the turbine rotor simply slows down and stops rotation in extreme winds.

In an additional embodiment, the electronic controller stalls the turbine rotor and limits power extraction from wind to the rated power in increasing wind speeds prior to reaching the maximum rotational speed. This effect can be accomplished by accurate selection of power and rotational speed for the stall control portion of the controller look up table. In many locations for wind turbine installation, the majority of the wind speed distribution is located near the lower end of wind speeds and high winds rarely occur. In these locations, it is advantageous to reduce the costs for the wind turbine structure, generator and electronics by having reduced power capability for the same turbine. The wind turbine may achieve its full rated power at a lower wind speed. In this embodiment, the wind turbine no longer continues to increase power to the load in increasing wind speeds prior to stopping. Instead, the wind turbine will continue to provide rated power to the load in increasing wind speeds prior to stopping. Once reaching rated power, the electronic controller may stall the turbine rotor such that power is limited to the rated power level and the rotor rotational may increase further with increasing wind speeds. An even steeper section of stall control may be added as the rotor approaches the maximum allowable rotational speed. As the wind speeds continue to increase beyond the desired operating wind speed range for the wind turbine, the power coefficient of the turbine rotor will switch and become negative for the operating tip speed ratio of the rotor. The rotor will slow down rotation in extreme winds (i.e., beyond a threshold or predetermined wind speed or correlated rotor rotation speed).

In a further embodiment, the wind turbine has a slightly different operation. The turbine rotor may self-start without a motor in low winds, the turbine rotor approximately provides peak power extraction in moderate winds, the turbine rotor is stalled by loading the generator under operation of the controller to lower tip speed ratios in high winds, and the turbine rotor slows rotation to a minimum rotation speed that maintains the low tip speed ration as the rotor power coefficient becomes no longer positive in very high winds. In this embodiment, the operation and starting of the turbine rotor may be passively enabled. No separate wind sensing and turbine starting and stopping control systems may be required. Whenever wind with speeds in the desired allowable operating range are present, the wind turbine can automatically operate to capture, extract and provide that energy to the electrical load.

In another embodiment, the turbine rotor may passively self-start when wind speeds decrease from the maximum or threshold wind speed that was reached to initiate slowing of the rotor rotation. For wind turbines that passively self-start in low wind, the wind turbine may also passively restart after being slowed from extreme winds above the desired operating wind speed range, once the wind speed drops. The passive restarting is enabled due to the power coefficient becoming positive again for even low values of operating tip speed ratio in the desired allowable operating wind speed range. Passive self starting can be achieved with Darrieus type turbines through, for example, a low drag mechanical bearing and generator set, proper airfoil selection, and a high rotor solidity.

The slowing or stopping of the turbine rotor to prevent fatigue or failure can be set to any value that acceptably limits the chance of damage to the wind turbine and also allows desired extraction of energy. In one example, a desirable wind speed for slowing or stopping turbine rotation is typically in the range of 15 m/s to 30 m/s. Slowing or stopping the wind turbine in this range of wind speed can prevent the most fatiguing cycles from high wind operation while still permitting the wind turbine to extract nearly all of the available wind energy or a given time period (e.g., week, month or year). Typically, wind speeds above this speed range occur for only a very limited time each year in most locations.

The wind turbine can be constructed with, for example, a parabolic shape rotor or a straight bladed giromill rotor. Each of these rotor configurations provides different advantages depending on the location of use for the wind turbine. Some example factors that influence the advantages of a particular wind turbine construction include stress, dynamic resonances, swept area per rotor width, shipping ability and costs. In the disclosed embodiments, the rotor may be constructed as a giromill having straight airfoils at a constant diameter. Because the airfoils are at a single diameter, the airfoils can rotate with a single tip speed ratio as opposed to a parabolic rotor with varying diameter. The single tip speed ratio may make the stalling and operation of the passive stopping (i.e., non-mechanical braking system) more precise.

The wind turbine can utilize different types of synchronous generators. In one embodiment, the synchronous generator is preferably an air core permanent magnet alternator. An air core permanent magnet alternator can provide the highest electrical efficiency. Even more advantageously, such alternators can have zero cogging and hence facilitate the self starting of the Darrieus wind turbine rotor. The self starting benefits can occur both at low wind speeds and also in high wind speeds after the rotor had been slowed or stopped due to extreme wind conditions and then the wind had dropped back into the desired allowable operating wind speed range.

The electrical load for the wind turbine can be either direct current (DC) or alternating current (AC). A wide variety of loads can directly benefit from renewable wind power from the example wind turbines of the present disclosure. In one embodiment, the electrical load is the AC utility grid. In this embodiment, the electronics controller can include a grid tie inverter. In another embodiment, the electrical load is a battery. In this embodiment, the electronic controller can include a battery charger.

The electronic controller can control the amount of power flow from the generator to the load by regulating (boosting and or bucking typically) the voltage from the generator that is supplied to the load. Other means of voltage regulation could also include an alternator with an excitable field coil. Excitable field coils may provide reduced efficiency as compared to a permanent magnet alternator. If the power from the generator to the load is greater than the rotor's power extraction from the instantaneous wind, then the rotational speed of the rotor slows. Likewise, if the power flow from the generator to the load is less than the rotor power extraction from the instantaneous wind, the rotational speed of the rotor increases. Furthermore, the electronic controller can maintain the optimal rotational speed of the rotor for maximum energy extraction from the wind for each wind speed.

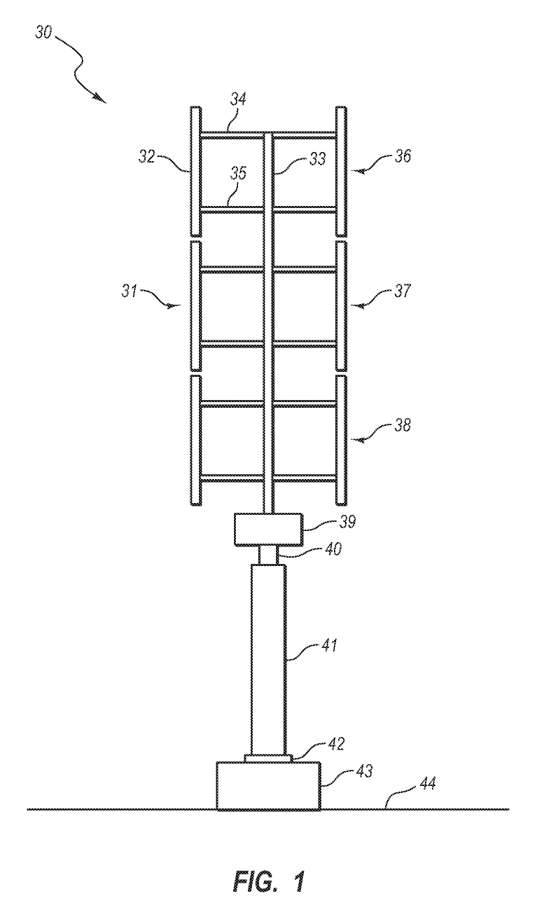

Turning now to the drawings, FIG. 1 shows an example vertical axis wind turbine 30 having a Darrieus type Giromill rotor 31. The rotor 31 is comprised of three airfoils 32 symmetrically arranged around a central shaft 33 and connected to the center shaft 33 by upper and lower struts 34, 35. The rotor 31 typically includes a plurality of vertical sections (i.e., three vertical sections 36, 37, 38 shown in the example of FIG. 1), such that flexing of the shaft 33 does not result in large bending stresses in the airfoils 32. The airfoils 32 can be constructed of composite materials such as fiberglass or extruded aluminum for low costs. One such common airfoil shape that works well in Darrieus turbines is symmetric airfoils such as NACA 0018 or similar. As the wind blows, the airfoils 32 generate lift and cause the shaft 33 to rotate. The shaft 33 drives an electrical generator 39 that generates electrical power. The generator 39 has a stationary portion 40 that is attached to a base pole 41 that supports the rotor 31 above the ground 44 and exposed to the wind.

Some parameters affecting operation of the wind turbine 30 may include the airfoil shape or profile, rotor solidity, number of blades, rotor diameter, camber and tow angle on the blades. In one example, turbine rotors with 3 NACA 0018 type airfoils having 5 inch chord and 3 degree tow angle in a 48 inch rotor diameter have the ability to slow or stop operation in the 15 m/s to 25 m/s wind speed range when stalled with a 1.2 kW rated inverter. Local wind conditions of gusty or constant wind may play a part in the actual shutdown or threshold wind speed (and corresponding rotor rotation speed) along with the amount of inertia of the rotor. Larger inertia rotors can take longer to slow down in high winds. Parameters for the rotor and turbine design may be adjusted so as to achieve a particular maximum wind operating speed. Cambered version airfoils such as the DU 06-W-200 and tow angles can be varied to affect the threshold maximum wind speed or rotor rotation speed.

The rotor 31 shown in FIG. 1 may be, for example, about 2 ft. to about 6 ft. in diameter, and more preferably about 4 ft. in diameter. A height of the rotor 31 may be in the range of about 15 ft. to about 25 ft., and more preferably about 20 ft measured from a top of the generator 39 to a top of the top tier of airfoils 36. The airfoil shape used in this example is known as NACA 0018. The airfoils 32 may have a chord length of about 3 in. to about 8 in., and more preferably about 5 in., and may have a length in the range of about 4 ft. to about 8 ft., and more preferably about 6 ft. These particular dimensions for this example wind turbine were selected to provide an electrical power output of about 1.2 kilowatts in a steady 11 m/s wind. Other sizes of rotors for different electrical outputs in different wind conditions are contemplated within the scope of the present disclosure.

A hinge 42, such as that shown in U.S. patent application Ser. No. 12/008,859 entitled “Residential Wind Turbine”, which application is herein incorporated in its entirety by this reference, anchors the base pole 41 to a concrete foundation 43 and allows the wind turbine 30 to be raised and lowered for servicing. During operation and especially during high winds, the shaft 33 becomes deflected downwind as the wind force exerts loading on the rotor 31. Continued operation of the rotor 31 with this deflection can cause fatigue to the wind turbine 30. Other components of the wind turbine 30 can also suffer from fatigue due to strain during exposure to high winds. Shut-down of the rotor during high winds in accordance with the present disclosure can alleviate this problem, as explained in more detail below.

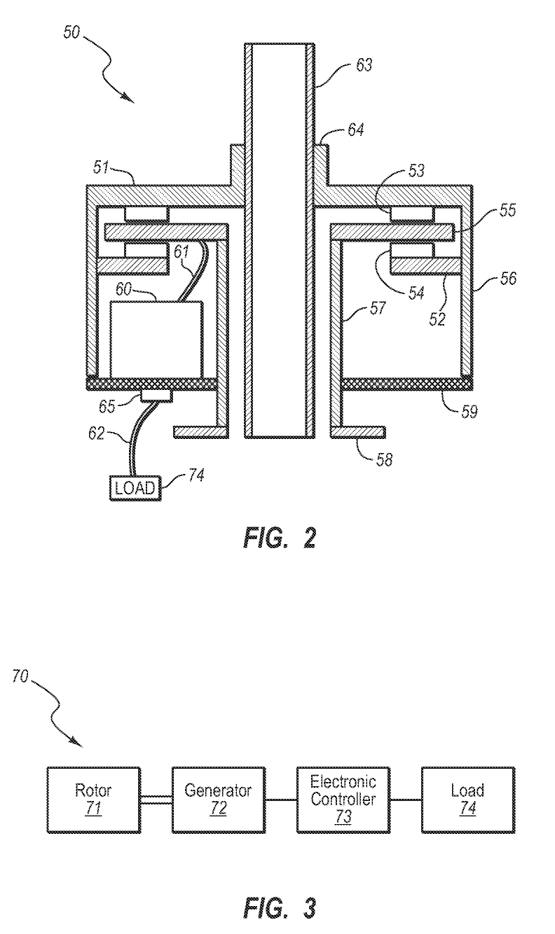

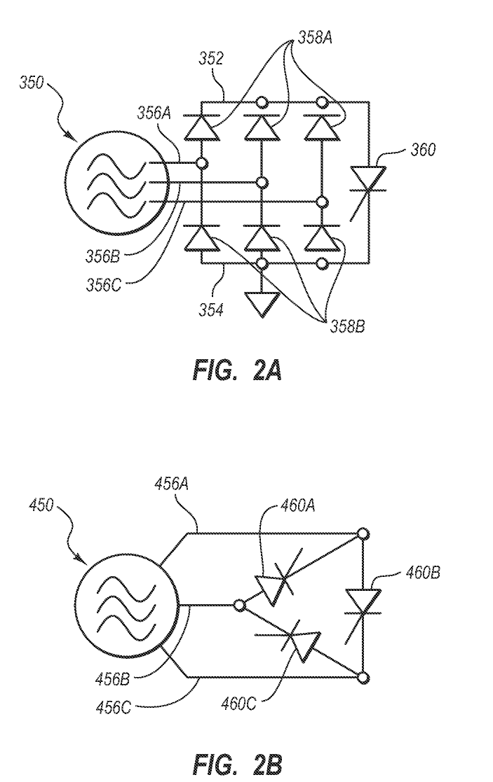

A schematic drawing of an example generator, corresponding to the generator 39 shown in FIG. 1, for use in a vertical axis wind turbine such as the wind turbine shown with in FIG. 1, is shown with reference to FIG. 2. Although Darrieus wind turbines can utilize different types of electrical generators, synchronous type generators allow the turbine rotor to operate at variable speed. This allows the wind turbines to capture and extract more energy from the wind, allows rotor speed control, and can eliminate the need for a gear box. One preferred type of synchronous generator is an air core permanent magnet alternator 50, shown in FIG. 2, (such as that shown in U.S. Pat. No. 7,042,109, the disclosure of which is hereby incorporated in its entirety by this reference).

The generator 50 includes two rotor portions 51 and 52 that are constructed of steel. Attached to the rotor portions 51, 52 are circumferential arrays of alternating polarity magnets 53, 54. The magnet arrays 53, 54 drive magnetic flux through a stationary armature 55 that is located therebetween. Windings in the armature produce electric voltage as the rotor portions 51, 52 rotate. The two steel rotor portions 51, 52 are joined together by an outer rotating housing 56 that seals the generator 50 against water and debris. The armature 55 is supported by a stator tube 57, which corresponds to the stationary portion 40 of the turbine shown in FIG. 1. A flange 58 at the bottom of the stator tube 57 couples to the stationary part of the wind turbine, which would be the base pole 41 in the turbine of FIG. 1.

Raw electric power is conducted from the armature 55 to electronic controller 60 by way of conductors 61. The electronic controller 60 may control the turbine rotor and provides output power via a connector 65 and conductor 62 to a load 74. An aluminum base plate 59 provides a heat sink for the electronic controller 60 and may seal the bottom of the generator 50. The top rotor portion 51 connects to the turbine shaft 63 (corresponding to, for example, the turbine shaft 33 shown in FIG. 1) through the use of a shaft collar clamp 64.

FIGS. 2A and 2B illustrate schematically portions of two example wind turbine electronic circuitries. With reference to FIG. 2A, a generator 350 includes a plurality of leads 356A-C used to couple the power output of the generator to a load. The leads 356A-C are electrically connected to positive and negative leads 352, 354 via sets of diodes 358A, 358B, respectively. A thyristor 360 may be coupled between the positive and negative leads 352, 354. When activated, the thyristor 360 creates an electrical short between the leads 356A-C. The electrical short in the leads 356A-C typically creates an electromotive force in the generator 350 that opposes rotation of the rotor that is driving the generator 350. This opposing electromotive force is sometimes referred to as an back electromotive force or back EMF. The back EMF in effect reduces the power output of the generator, and can be used to reduce the power output to a sufficiently low level that the generator produces enough power to operate, for example, minimal function of the wind turbine such as activation of the thyristor to maintain the back EMF. The example shown in FIG. 2A may be referred to as a DC shunt brake.

Advantageously, the back EMF can operate within the generator to functionally brake or slow down rotation of the rotor without the use of a mechanical braking device. The thyristor can be replaced in the wind turbine circuitry with other devices that provide the similar functions. In one example, the thyristor is replaced with a silicone controlled rectifier or a TRIAC.

With reference to FIG. 2B, a generator 450 includes a plurality of leads 456A-C used to couple the power output of the generator to a load. The leads 456A-C are electrically connected to each other via a plurality of silicone controlled rectifiers (SCRs) 360A-C may be coupled between the leads 456A-C. When activated, the SCRs 360A-C creates an electrical short between the leads 456A-C. The electrical short in the leads 456A-C typically creates an electromotive force in the generator 450 that opposes rotation of the rotor that is driving the generator 450. As with the generator 350 described above, this back EMF in effect reduces the power output of the generator 450, and can be used to reduce the power output to a sufficiently low level that the generator produces enough power to operate, for example, minimal function of the wind turbine such as activation of the thyristor to maintain the back EMF. The example shown in FIG. 2A may be referred to as a delta SCR brake.

Other types of non-mechanical braking systems and methods may be employed in the wind turbines disclosed herein for use in slowing rotation speeds of a rotor when a threshold wind speed is reached. In one example, the electronic controller in cooperation with other features of the wind turbine perform proportional braking of three phase motor with multiple SCRs across the windings of the generator. The amount of phase control braking may be proportional to an analog input. In one example, phase braking is controlled to be a function of a PW modulated input. A phase of the motor can be read from multiple analog inputs, such as a comparator input and a analog input from the current of the motors windings. The SCRs may be activated with, for example, a 3 microsecond pulse and stay activated for the remaining cycle. In circumstances where the current is monitored by the controller, the current may go to zero and turn off the SCR thereby giving a indication of phase and rpm of the rotor, which can be used to sync the processor.

In an example operation (e.g., with reference to the circuitry of FIG. 2A or FIG. 2B), a first step includes syncing off the an A-B phase of the generator. A B-C phase may be assumed to lag by 120 degrees. Calibration for offsets may be required. The brake will act on the B-C phase for initial braking of up to about 45 degrees, after which point braking with begin in the A-B phase also. At that time a switch to using the current going through the A-B phase to short the SCR will be made for syncing and rpm detection. A current going through the SCR may go to zero or close to zero, representing a 0 phase crossover. On loss of AC power, ramping of the brake may occur for about 4 seconds and then the full braking is applied. As noted above, other devices may be used in place of an SCR (e.g., a TRIAC or thyristor). Other braking systems for use in the example wind turbines disclosed herein are described in U.S. Patent Application No. 61/187,625, filed on Jun. 16, 2009 and titled ELECTRIC GENERATOR POWER CONTROL, which application is hereby incorporated in its entirety by this reference.

A schematic drawing of a control system 70 for a vertical axis wind turbine such as the wind turbine of FIGS. 1 and 2 is shown with reference to FIG. 3. The control system 70 may comprise the turbine rotor 71 (corresponding to the turbine rotor 31 in FIG. 1), which drives the generator 72 (corresponding to the generator 39 in FIG. 1 and the generator 50 in FIG. 2) to produce raw electrical power. The electronic controller 73 may control the wind turbine by taking the power from the generator 72 and providing power to the electrical load 74. The electronic controller 73 can control the speed of the rotor 71 and its power extraction from the wind by the power provided to the load 74.

The load 74 can be either AC or DC. In one embodiment, the load 74 is an AC utility power grid. In the case of an AC utility power grid, the electronic controller 73 includes a grid tie inverter (not shown) that converts power from the generator into AC synchronized with the grid 74. In another embodiment, the load 74 is a battery for use in off-grid installations, such as electric vehicle battery charging. In this case, the electronic controller 73 serves as a battery charger that adjusts the power from the generator 72 and provides regulated DC power to the battery 74 for charging and driving DC loads.

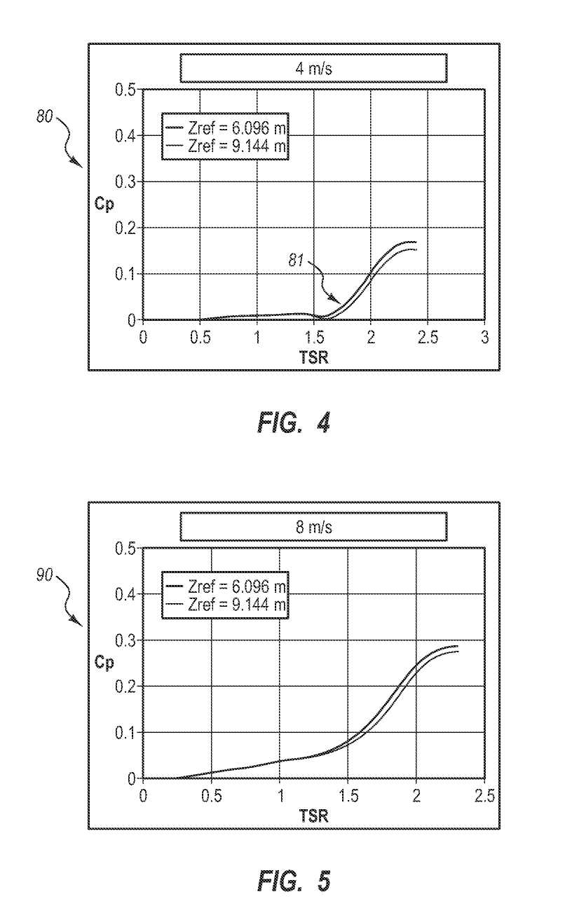

A plot of a power coefficient (Cp) versus tip speed ratio (TSR) curve in FIG. 4 of the vertical axis wind turbine shown in FIG. 1. Shown is a plot 80 for the turbine response in low wind at 4 m/s. The two curves shown are for the same rotor, but are based on two different wind measurement heights, 6.096 m and 9.144 m. Below 4 m/s, wind typically does not have sufficient energy for efficient extracting. When wind speeds reach 4 m/s, it is usually desirable to start wind turbine operation. In low winds e., in the range of 4 m/s), a Darrieus type turbine rotor has very low starting torque and for many designs even has a deadband such that no torque exists to accelerate the rotor past a range of tip speed ratios. The plot 80 shows that the rotor has a near deadband 81 where only a very small positive torque exists to self start the turbine to full speed. Because the power coefficient (Cp), is positive at all values of tip speed ratio (TSR), the wind turbine will eventually self start if well designed. A well designed turbine will have low mechanical drag and a high performance airfoil with sufficiently high solidity so as to self start in low winds.

In higher wind speeds (i.e., greater than 4 m/s), Darrieus turbine rotors typically more easily self start as shown in FIG. 5 in the plot 90 of a power coefficient versus tip speed ratio curve of the vertical axis wind turbine shown in FIG. 1, showing the turbine response in moderate wind at 8 m/s. The power coefficient shows no deadband and is highly positive at all values of operating tip speed ratio.

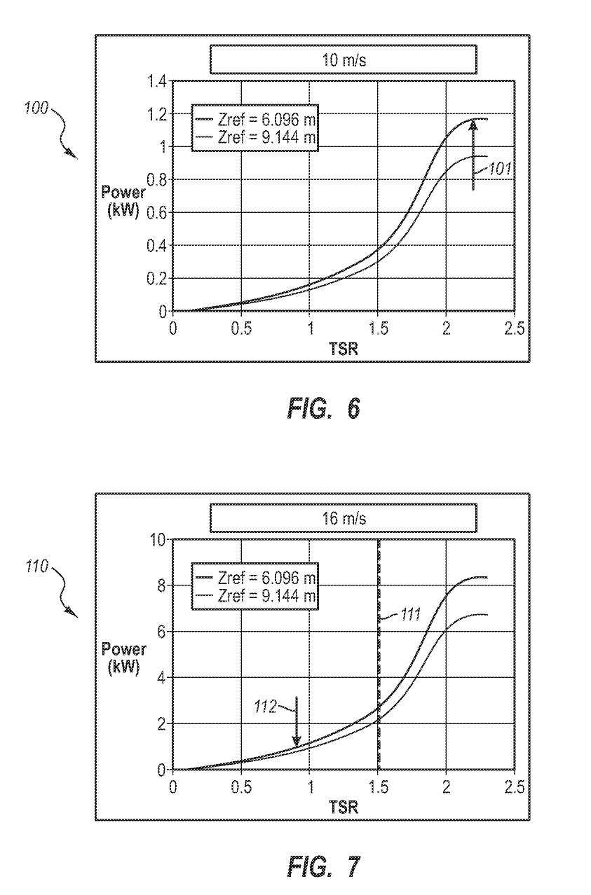

In moderate wind speeds, it is preferable that the rotor be operated at the operating tip speed ratio that provides the maximum energy production. With reference to FIG. 6 in a plot 100 of power versus tip speed ratio curve of the vertical axis wind turbine shown in FIG. 1 over a range of tip speed ratios in moderate wind operation of 10 m/s, the peak power extraction occurs at point 101. This tip speed ratio may be maintained by the electronic controller, as described below. For the vertical axis wind turbine shown, this corresponds to maintaining the rotor operation at approximately a tip speed ratio of about 2.3.

A plot 110 of power versus tip speed ratio for the vertical axis wind turbine shown in FIG. 1 is shown in FIG. 7 for operation in high wind of 16 m/s. Note that the numerical values of wind speeds constituting low, moderate high and high winds depend on the specific wind turbine and the values presented apply only to the wind turbine of this example. In high winds, the electronic controller may stall the turbine rotor, which reduces the operating tip speed ratio to below the tip speed ratio for peak power extraction. In one embodiment, the electronic controller holds the rotational speed of the rotor at near the maximum allowable rotational speed by increasing the rate of power increase to the load from small changes in rotational speed above the desired maximum rotational speed.

The maximum allowable rotational speed in this case may correspond to operating point 111 and a tip speed ratio of about 1.5 in 16 m/s wind. As the wind speed increases in high wind, the tip speed ratio is thereby reduced further to a low tip speed ratio. The term “low tip speed ratios” as used throughout are those that are below the tip speed ratio corresponding to the maximum power coefficient for the rotor, and more preferably less than half of the tip speed ratio corresponding to the maximum power coefficient.

In another embodiment, the electronic controller holds the output power at a constant rated power value in increasing high winds by stalling the rotor to limit power transfer to the load. As the wind speed increases further, the rotational speed may further increase. This method limits the output power and allows the generator and electronics to be substantially reduced, reducing costs. In this case, the rotor operating point 112 corresponds to the rated power of about 1.2 kW and a tip speed ratio of about 0.9 in 16 m/s wind. Upon reaching the maximum allowable rotational speed, the electronic controller limits the rotational speed by very steeply ramping the power values per rotational speed increases.

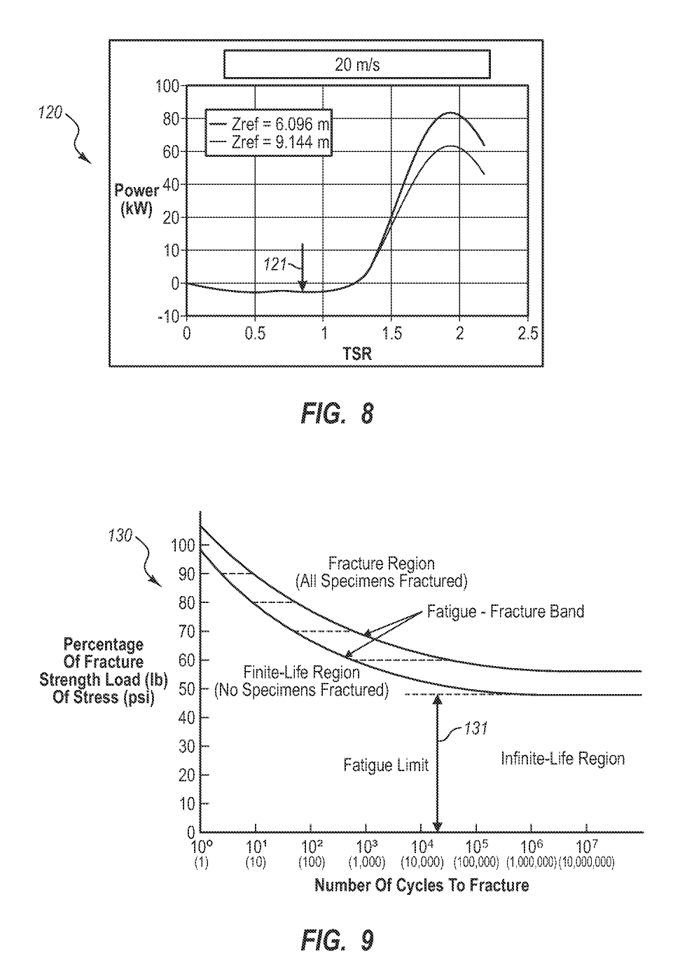

A plot 120 of a power versus tip speed ratio curve of the vertical axis wind turbine shown in FIG. 1 is shown in FIG. 8 for very high wind speed of 20 m/s. At this speed, the rotor typically would deflect significantly and it is desirable to significantly slow or stop the turbine rotation to reduce wind turbine fatigue which can extend the operating life of the wind turbine. With the turbine rotor previously operating at reduced rotational speeds and tip speed ratios by the action of the electronic controller in high wind operation (e.g., 18 m/s), the performance of the rotor now switches and becomes negative as the wind speed is further increased. The operating point 121 corresponds to the operating tip speed ratio just as the wind speed increases to 20 m/s. As shown, the power output or power coefficient of the rotor becomes negative. The power coefficient can become negative via operation of the generator as controlled by the electronic controller. This negative power coefficient tends to oppose rotation of the rotor and slow the rotor rotation without the use of mechanical devices. Because the power is negative for all values down to approximately zero speed, the rotor precludes significant further rotation as long as the wind speed stays at 20 m/s or higher. Thus, the rotor is designed to have a power coefficient at low values of tip speed ratios that becomes negative for wind speeds exceeding a predetermined wind speed value.

The maximum predetermined value may be at any level. In at least some examples, the predetermined maximum value or threshold value is in the range of about 15 m/s to 25 m/s, and more preferably in the range of about 15 m/s to 20 m/s. The electronic controller cooperates with the turbine rotor such that the turbine rotor looses a positive power coefficient and the wind turbine slows or stops operation when wind speeds exceed the predetermined wind speed value.

If the wind speed drops lower, the power curve looses the negative torque portion at low tip speed ratios, like shown in plot 110 of FIG. 7. As a result, the rotor may self start and continue wind turbine operation automatically.

A fatigue curve for steel for a vertical axis wind turbine in accordance with the present disclosure is shown in FIG. 9. The plot 130 shows the fatigue life for the turbine shaft as a function of the stress. The stress on the shaft is a function of the wind load, which is approximately proportional to the square of the wind speed. The cycle life may be a logarithmic scale such that small changes in the shaft stress can make a substantial difference in the number of cycles before a fatigue failure. When the shaft stress becomes sufficiently low, the fatigue limit 131 or endurance limit is approached. At this stress level, the wind turbine can operate nearly indefinitely without having a fatigue failure. Although not always possible, it is typically desirable to avoid operating the wind turbine in winds that result in stress above the fatigue limit 131.

In very high wind speeds (i.e., in the range of 15 m/s to 25 m/s, such as the 20 m/s example described above), it is desirable to stop the rotation of the turbine to prevent fatigue failure in the wind turbine. To stop the rotation of the rotor, the rotor is stalled by the controller to operate at a tip speed ratio corresponding to the desired level of output power. The rotor is designed to lose positive torque at a particular wind speed. The wind speed at which the loss of positive torque occurs can be a function of several different aerodynamic parameters. One parameter is the operating tip speed ratio of the rotor in the wind speed. Higher output turbines for a given rotor may operate at a higher tip speed ratio for more power production in high winds.

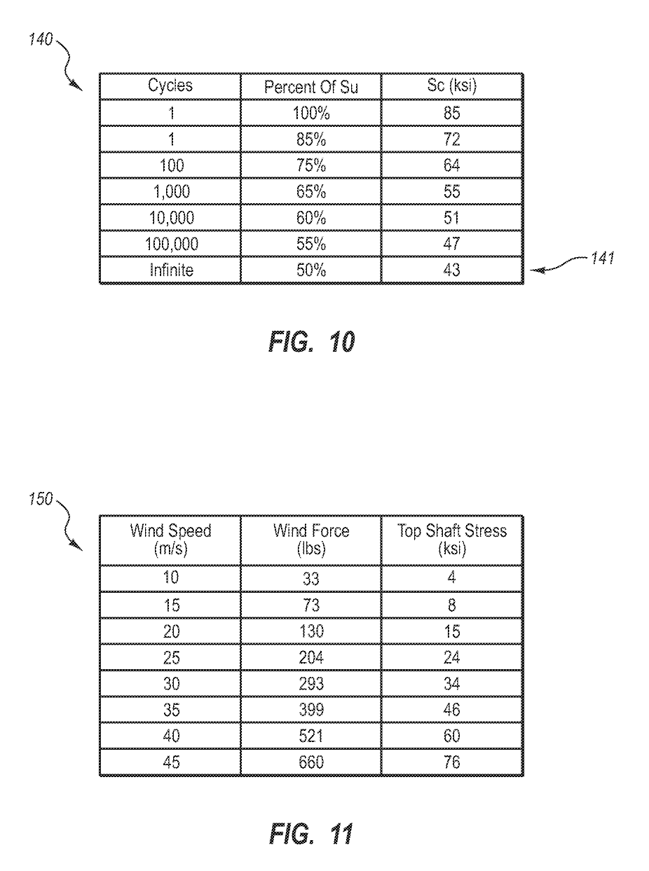

A stress versus cycle life table of steel for a vertical axis wind turbine in accordance with the present disclosure is shown in FIG. 10. The table 140 shows the number of cycles to failure as a percentage of the ultimate strength of the shaft or component. For the steel shaft shown, the cycle life becomes relatively indefinite at about 50% of the ultimate stress. This approximate endurance limit 141 is common for many materials although other factors such as surface conditions and stress concentrations can further lower this value. The top shaft shown may cycle indefinitely for all stress levels of, for example, 43 ksi or less.

A wind speed versus top shaft stress table for a vertical axis wind turbine in accordance with the present disclosure is shown in FIG. 11. The table 150 shows a dramatic increase in the top shaft stress with increasing wind speed. For many turbine designs, the stress to wind speed relationship is approximately a square function. For wind speeds of 30 m/s and below, the top shaft may exhibit an infinite cycle life as the shaft stress is below the previous endurance limit of 43 ksi.

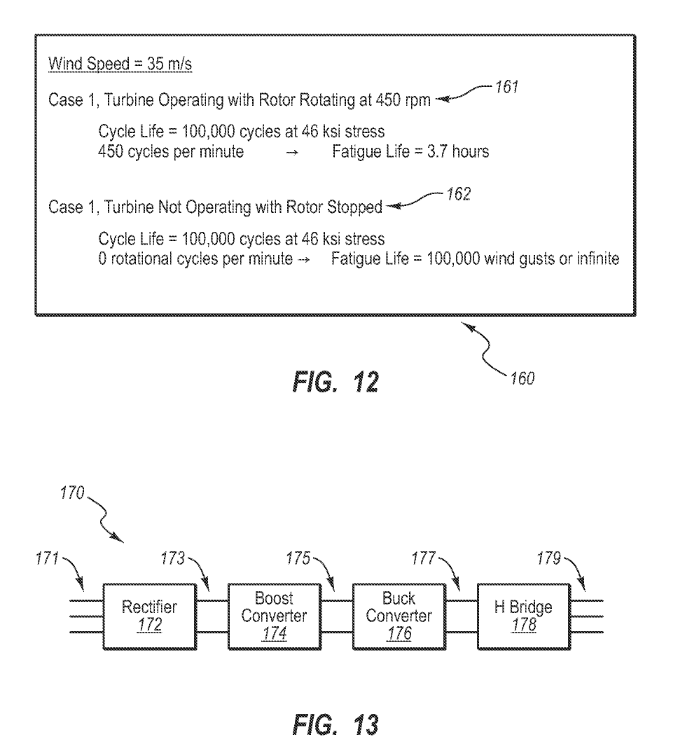

A stress calculation of fatigue life for the top shaft of a vertical axis wind turbine in accordance with the present disclosure is shown in FIG. 12. The calculation 160 is broken into two cases: Case 1, 161, where the turbine continues to rotate and Case 2, 162, where the turbine is significantly slowed or stopped. In both cases the wind speed is 35 m/s. At this wind speed, the top shaft is deflected and the shaft stress is 46 ksi, which is higher than the endurance limit for the steel shaft. In Case 1, 161, with the turbine continuing to rotate at 450 rpm, the fatigue life of about 100,000 cycles is quickly achieved in only 3.7 hours, illustrating that in less than 4 hours of operation in this high wind, the wind turbine may experience a shaft structural fatigue failure.

In Case 2, 162, with the turbine stopped, the shaft fatigue cycles are only incremented by the number of wind gusts. With a fatigue life of 100,000 cycles at the corresponding wind speed, the life of the wind turbine would be essentially infinite and the shaft typically does not experience a structural fatigue failure. Further adding to the possibility of extended life for the wind turbine life is that a stress cycle from a wind gust is much shallower and does not swing from full tension to full compression. As a result, the number of wind gusts to cause a fatigue failure would be substantially higher than 100,000 cycles. Thus, the wind turbine reduces mechanical fatigue by stopping the turbine rotor in high winds by reducing the tip speed ratio of the turbine rotor with the electronic controller in combination with the aerodynamic loss of torque of the turbine rotor.

A schematic block diagram of an electronic controller for use in a vertical axis wind turbine in accordance with the present disclosure is shown in FIG. 13. The electronic controller 170 comprises a rectifier 172 that converts the alternator power 171 into direct current 173. The direct current power 173 is boosted by the boost converter 174 to a higher voltage 175. The higher voltage 175 is bucked with a buck converter 176 to a regulated voltage 177. For driving AC loads 179, an H bridge inverter 178 may be used to convert the regulated DC 177 into AC 179. The electronic controller 170 can thereby vary the load to the alternator power 171 and resultantly the power delivered to the electrical load 179. The electronic converter can have other configurations and orders of conversion operations so long as the converter as able to effectively control the flow of power from the generator to the load. Likewise, the electronic converter can also work to drive DC loads without the use of an H bridge.

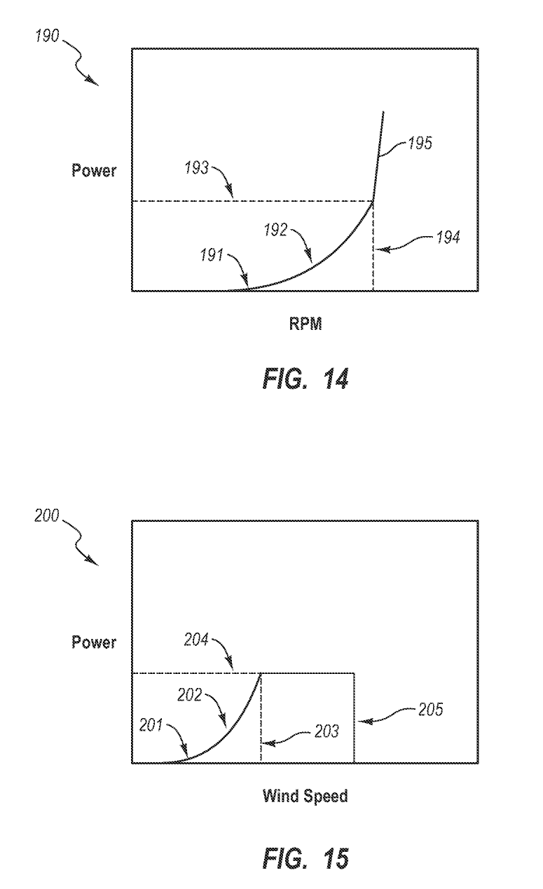

A plot of the power versus RPM control for a vertical axis wind turbine in accordance with the present disclosure is shown in FIG. 14. The plot 190 shows the cut in rotational speed 191, at which the rotor has sufficient speed for the turbine to start providing power. The electronic controller will start providing power from the generator to the load at the cut in speed 191. The electronic controller ramps the power from the generator to the load in the operating speed range 192. The electronic controller preferably controls the rotor to operate at its peak power coefficient, by accurate control of power per rotational speed. Upon reaching the maximum rotational speed 194, the wind turbine is supplying the rated power 193. If the wind speed increases further, a steep ramp 195 of the power transfer per rotational speed increase works to limit the rotational speed and prevent over speeding. Gusts in the wind may cause spikes in rotational speed and power. However, these spikes can be limited to acceptable values through careful design and tailoring of the steep ramp 195. The rotational speed of the rotor may be kept near its maximum allowable value, which is typically less than 20% deviation from spikes and more preferably less than 10% deviation from the spikes.

A plot of power versus wind speed for a vertical axis wind turbine in accordance with the present disclosure is shown in FIG. 15. The plot 200 shows a cut in wind speed 201 at which there is sufficient wind energy for the wind turbine to start supplying power to the load. In increasing wind speeds, the power exponentially ramps 202 by preferably tracking the peak power coefficient of the rotor for maximum energy generation. When the wind speeds reach the rated wind speed 203, the wind turbine is supplying its rated power. The turbine will preferably continue to provide near rated power 204 for wind speeds above the rated wind speed 203. When the wind speeds approach very high values, the turbine typically automatically stops operation 205 via operation of the electronic controller. At this point, the power coefficient will have dropped off or become negative for the tip speed ratio at which the rotor is operating. The rotor will significantly slow or stop rotation and maintain that slowed or stopped condition for all higher wind speeds above the threshold level, thereby protecting the turbine from fatigue failures.

It can thus be seen that the embodiments described above may provide many advantages such as, without limitation:
Automatic operation of a wind turbine to slow rotor speed upon reaching a threshold wind speed (or associated rotor rotation speed).
Automatic acceleration of the rotor rotation speed after slowing of the rotor rotation speed due to high wind speed or high rotor speed and upon the wind speed dropping below the threshold wind speed.
Slowing rotor speed using a non-mechanical braking system.
Using an electronic controller to monitor wind speed, control operation of a wind turbine generator to modify rotation speeds of the rotor, and control power output from the generator.
Control rotor rotation speed using a back electromotive force (back EMF) applied in the generator that opposes rotation of the rotor.
Controlling rotor speed by creating an electrical short in the generator that opposes an electromotive force present in the generator created by rotation of the rotor.
The use of a thyristor, silicone controlled rectifier (SCR), or TRIAC to create an electric short condition in the generator, wherein the thyristor, SCR or TRIAC is activated by an electronic controller in response to wind speed.

The preceding description has been presented only to illustrate and describe exemplary embodiments of the present disclosure. It is not intended to be exhaustive or to limit the invention to any precise form disclosed. Many modifications and variations are possible in light of the above teaching. It is intended that the scope of the invention be defined by the following claims.

What is claimed is:

1. A wind turbine, comprising:
a rotor configured to rotate about a vertical axis;
a generator driven by rotation of the rotor;
a controller operatively coupled to the rotor and generator, the controller being operable to monitor a rotation speed of the rotor and control the generator to reduce the rotation speed of the rotor when the rotation speed exceeds a predetermined level.

2. The wind turbine of claim 1, wherein the generator includes at least one permanent magnet that creates an electronic current when rotated by the rotor.

3. The wind turbine of claim 2, wherein the controller causes an electronic short to occur in the generator that opposes the electronic current upon the rotation speed exceeding the predetermined level, thereby slowing rotation of the rotor.

4. The wind turbine of claim 3, further comprising a thyristor which when activated by the controller creates the electronic short to occur in the generator.

5. The wind turbine of claim 1, wherein the rotor maintains at least some rotation speed to power the controller.

6. The wind turbine of claim 1, wherein the controller is configured to control the flow of electrical power generated by the generator.

7. The wind turbine of claim 1, wherein the controller is configured to correlate the rotator rotation speed with a wind speed that rotates the rotor.

8. The wind turbine of claim 1, wherein rotor is a Darrieus type turbine rotor.

9. The wind turbine of claim 1, wherein the rotor includes a giromill.

10. The wind turbine of claim 1, wherein the generator comprises an air core permanent magnet alternator.

11. The wind turbine of claim 1, wherein the controller is operable to maintain the rotor at a constant rotation speed.

12. A method of controlling rotation speed of a wind turbine, the method comprising:
providing a wind turbine having a rotor, a generator and a controller;
rotating the rotor with wind energy;
rotating at least a portion of the generator with the rotor to create an electrical current;
controlling the generator with the controller to modify a rotation speed of the rotor when the rotation speed exceeds a predetermined level.

13. The method of claim 12, wherein the generator includes at least one fixed magnet and a set of windings, and controlling the generator includes creating an electrical short in the windings that creates a back electromotive force, the back electromotive force acting upon the fixed magnet to oppose rotation of the rotor.

14. The method of claim 12, wherein controlling the generator includes providing a force within the generator that opposes rotation of the rotor.

15. The method of claim 12, further comprising controlling the generator to maintain a constant rotation speed of the rotor.

16. The method of claim 12, modifying the rotation speed includes reducing the rotation speed to create a reduced tip speed ratio of the rotor.

17. The method of claim 12, further comprising controlling the generator to maintain the rotation speed of the rotor at a maximum rotation speed for a given wind speed that is below the predetermined level.

18. The method of claim 12, wherein the predetermined level correlates to wind speeds within the range of about 15 m/s to about 30 m/s.

19. The method of claim 12, further comprising electrically coupling the electrical current to a utility power grid.

20. The method of claim 12, wherein the predetermined level correlates with a threshold wind speed, and the controller permits an increase in rotation speed of the rotor when the wind speed decreases from the threshold wind speed.
